(19) United States
(12) Patent Application Publication
(10) Pub. No.: US 2007/0260546 A1
(43) Pub. Date: Nov. 8, 2007

(54) Apparatus and Method for Serving Digital Content Across Multiple Network Elements

(76) Inventors: Glenn Darrell Batalden, Rochester, MN (US); Theodore Brian Vojnovich, Cary, NC (US)

Correspondence Address: MARTIN & ASSOCIATES, LLC, P.O. BOX 548, CARTHAGE, MO, 64836-0548, US

(21) Appl. No.: 11/381,382

(22) Filed: May 3, 2006

(51) Int. Cl. G06Q 99/00

(52) U.S. Cl. 705/51

(57) ABSTRACT

An apparatus and method use a scale out paradigm to spread digital content across multiple servers, which then deliver the content in parallel to a client. Spreading content over multiple servers allows easily expanding memory and I/O capabilities at a reasonable cost. The client includes a mechanism for receiving the content on multiple channels from multiple server computer systems, and for assembling the content into a single stream. The result is a system that may be easily scaled to provide digital content to an increasing number of users at a reasonable cost.

### BACKGROUND OF THE INVENTION

1. Field of the Invention

This invention generally relates to networked computer systems, and more specifically relates to an apparatus and method for serving digital content.

2. Background Art

The internet has become a common medium for transmitting digital content. Digital content as used herein means any suitable digital information that may be transmitted via any type of network. Music and video files are examples of digital content. Recent attention has been placed on providing video information on demand. Video on demand allows a user to select when they want to view a television program or movie. For example, if the user is unable to watch the ten o'clock news because she is not home, but then returns home later and is ready at 11:30 PM to watch the newscast, a video on demand system will allow the user to watch the video of the ten o'clock news on demand, when the user requests it. Movies on demand provides significant advantages to current pay-per-view products that provide a schedule to the user and require the user to subscribe to a movie that will be played at a predetermined time according to the published schedule. Television providers have recognized the desirability of offering video on demand to their customers.

Known solutions to providing digital content on demand typically use a powerful and expensive computer system to deliver the digital content. With the advent of high-definition television (HDTV), the bandwidth requirements have increased significantly. A typical HDTV broadcast requires over five times the digital data as a regular television broadcast. The known solutions in the art are limited in the number of customers that can be serviced according to the memory and I/O limitations of the computer system. As a result, if more customers need to be served, more powerful and expensive computer systems must be added. This is known in the art as a “scale up” paradigm, where the size and complexity of a computer system is increased before adding another computer system to increase capacity. Without a way to provide a more economical way to deliver digital content, current methods for providing video on demand and other digital content will be excessively expensive.

### BRIEF SUMMARY OF THE INVENTION

According to the preferred embodiments, an apparatus and method use a scale out paradigm to spread digital content across multiple servers, which then deliver the content in parallel to a client. Spreading content over multiple servers allows easily expanding memory and I/O capabilities at a reasonable cost. The client includes a mechanism for receiving the content on multiple channels from multiple server computer systems, and for assembling the content into a single stream. The result is a system that may be easily scaled to provide digital content to an increasing number of users at a reasonable cost.

The foregoing and other features and advantages of the invention will be apparent from the following more particular description of preferred embodiments of the invention, as illustrated in the accompanying drawings.

### BRIEF DESCRIPTION OF THE SEVERAL VIEWS OF THE DRAWING(S)

The preferred embodiments of the present invention will hereinafter be described in conjunction with the appended drawings, where like designations denote like elements, and:

FIG. 1 is a block diagram of a server computer system in accordance with the preferred embodiments;

FIG. 2 is a block diagram of a prior art networked computer system for providing digital content to multiple clients;

FIG. 3 is a block diagram of a prior art client;

FIG. 4 is a flow diagram of a prior art method for delivering digital content to a requesting client;

FIG. 5 is a block diagram of a networked computer system in accordance with the preferred embodiments for providing digital content to multiple clients using multiple servers;

FIG. 6 is a block diagram of a client in accordance with the preferred embodiments;

FIG. 7 is a flow diagram of a method in accordance with the preferred embodiments for providing digital content to multiple clients using multiple servers;

FIG. 8 is a block diagram of a sample networked computer system for illustrating the concepts of the preferred embodiments;

FIG. 9 is a table showing data received by the client 175A in FIG. 8 from multiple servers over multiple connections; and

FIG. 10 is a table showing the data in FIG. 9 after assembling the data into a single data stream.

### DETAILED DESCRIPTION OF THE INVENTION

The preferred embodiments provide an economical and efficient way to provide digital content to a large number of users. The digital content is spread over multiple servers, and the multiple servers then deliver their content to a client over multiple connections. The client then assembles the content received on multiple connections into a single data stream. By spreading the content over multiple servers and multiple connections, a greater number of users may be served at an economical cost.

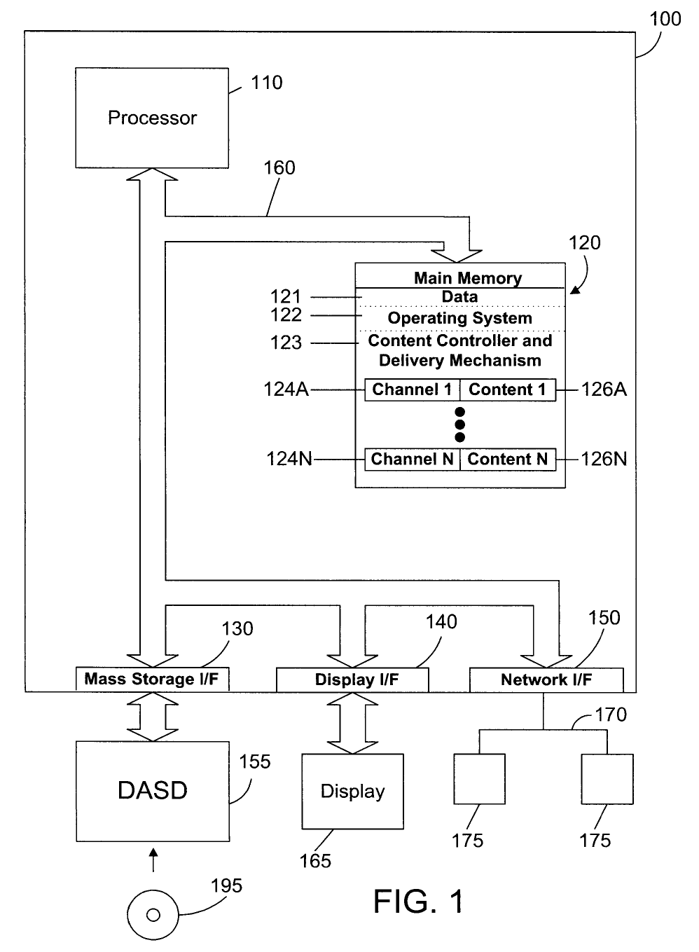

Referring to FIG. 1, a computer system 100 is one suitable implementation of an apparatus in accordance with the preferred embodiments of the invention. Computer system 100 is an IBM Blade computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable DVD drive, which may store data to and read data from a DVD 195.

Main memory 120 in accordance with the preferred embodiments contains data 121, an operating system 122, and a content controller and delivery mechanism 123. Data 121 represents any data that serves as input to or output from any program in computer system 100. Operating system 122 is a multitasking operating system known in the industry, such as Linux or Windows; however, those skilled in the art will appreciate that the spirit and scope of the present invention is not limited to any one operating system. Content controller and delivery mechanism 123 controls the distribution of digital content to multiple servers. The content controller and delivery mechanism 123 determines how content will be spread across network elements, and delivers content across multiple channels to multiple users. The content controller and delivery mechanism 123 is shown in FIG. 1 sending content over multiple channels. Thus, content 126A is sent on channel 124A, and so on, through content 126N which is sent on channel 124N. The preferred embodiments expressly extend to any suitable number of channels, and any type of digital content. In the most preferred implementation, the digital content is delivered based on a logical unit of delivery. For example, for digital movies, a video frame may be a suitable logical unit of delivery. For games, a logical unit of deliver may be a screen shot. For audio, a logical unit of delivery may be a specified number of bytes. The preferred embodiments expressly extend to any suitable logical unit of delivery for the digital content, including a logical unit of delivery that vanes.

One of the advantages of the content controller and delivery mechanism 123 is the ability to determine which digital content is in the memory 120 and which is in mass storage, such as DASD 155. If a particular selection is in high demand, the portions of that selection on a given server may be kept in the memory 120 so the content may be served quickly, instead of requiring a read from mass storage to get the data that needs to be served. In other words, “hot” data may be kept in memory, while data that is in less demand may remain in mass storage. Thus, with the release of a new movie to an on-demand system, the entire movie may be kept in the memory of the several servers that host the portions of the movie to assure high performance in rendering the movie to users. As demand for the movie drops off, it may be moved from memory 120 to DASD 155, thereby making space for other content in memory 120 that is in higher demand. Note that traditional caching algorithms may be used to determine which content is stored in memory and which is stored in mass storage, and to handle the transfer of content back and forth between memory and mass storage. The simple example described above shows only two levels of memory, but one skilled in the art will recognize that many levels of memory hierarchy may exist in a computer system. For example, a computer system may include RAM, local DASD, networked DASD, CD, DVD, archival storage, etc.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, and content controller and delivery mechanism 123 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable media used to actually carry out the distribution. Examples of suitable computer-readable media include: recordable type media such as CDs or DVDs (e.g., 195 of FIG. 1), and transmission type media such as digital and analog communications links.

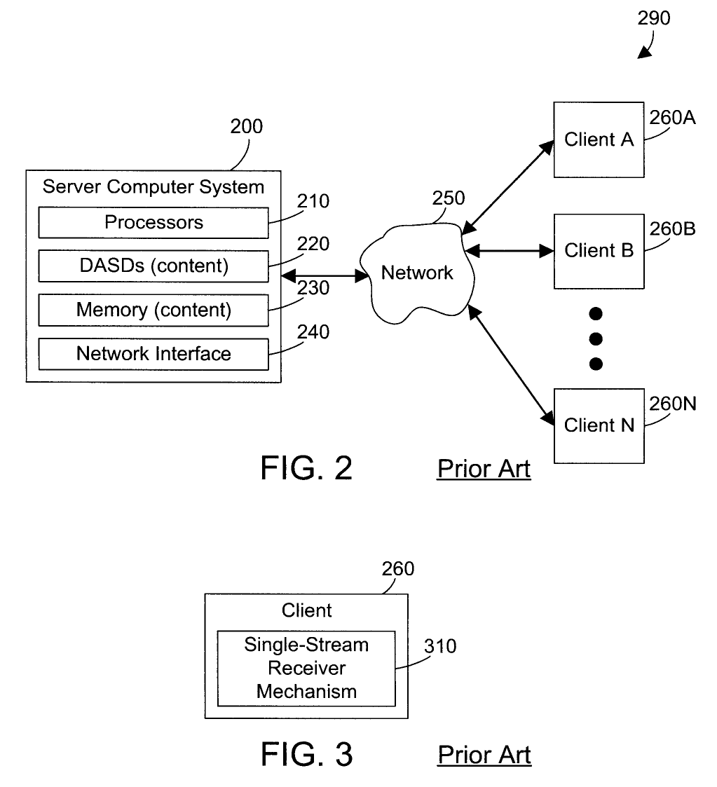

A prior art system and method for serving digital content is now presented to provide context for understanding the preferred embodiments. Referring to FIG. 2, a prior art networked computer system 290 includes a server computer system 200 coupled to a network 250, which is coupled to multiple clients 260, shown in FIG. 2 as clients 260A, 260B, . . . , 260N. Server computer system 200 includes one or more processors 210, a direct access storage device 220 (such as a hard disk drive), memory 230, and a network interface 240. Note that digital content may reside in one of the DASDs 220 or in memory 230. The prior art networked computer system 290 may be referred to as a “scale up” paradigm, where additional capacity for delivering digital content is added by increasing the resources in the server computer system 200.

A sample prior art client computer system 260 is shown in FIG. 3 to include a single-stream receiver mechanism 310 that receives a single stream of data from server computer system 200. This single stream of data is rendered to the user of the client 260. One suitable example for client 260 is a set-top box that receives video-on-demand (VOD) content from the server computer system 200. When the content is delivered from the server computer system 200 to the client 260 shown in FIG. 3, the single-stream receiver mechanism 310 receives the content, and the content may then be rendered to the user.

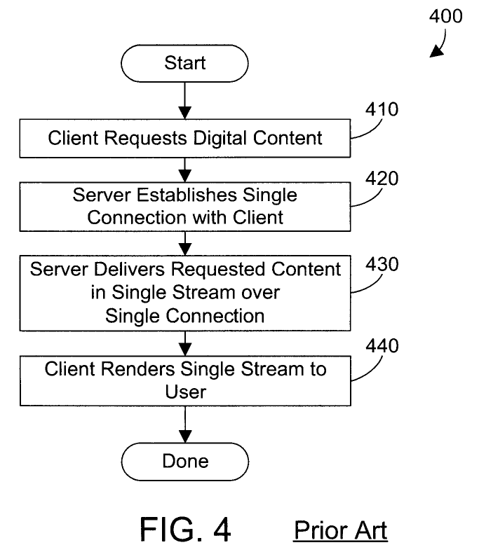

Referring to FIG. 4, a prior art method 400 for the networked computer system 290 in FIG. 2 begins by a client requesting digital content (step 410). The server establishes a single connection with the client (step 420). The server delivers the requested content in a single stream over the single connection to the client (step 430). The client then renders the single stream of content to a user (step 440).

One problem with the “scale up” approach to delivering digital content is constraints that arise due to limited memory and a limited number of network connections. Because the digital content is delivered in a single stream to the client, this requires a single network connection for each client. Once the number of clients rises to exceed the number of network connections available, a second computer system 200 as shown in FIG. 2 would have to be added. Server computer systems 200 are relatively expensive because they typically have numerous processors 210, a large number of DASD devices 220, a relatively large amount of main memory 230, and as much network interface logical 240 as possible.

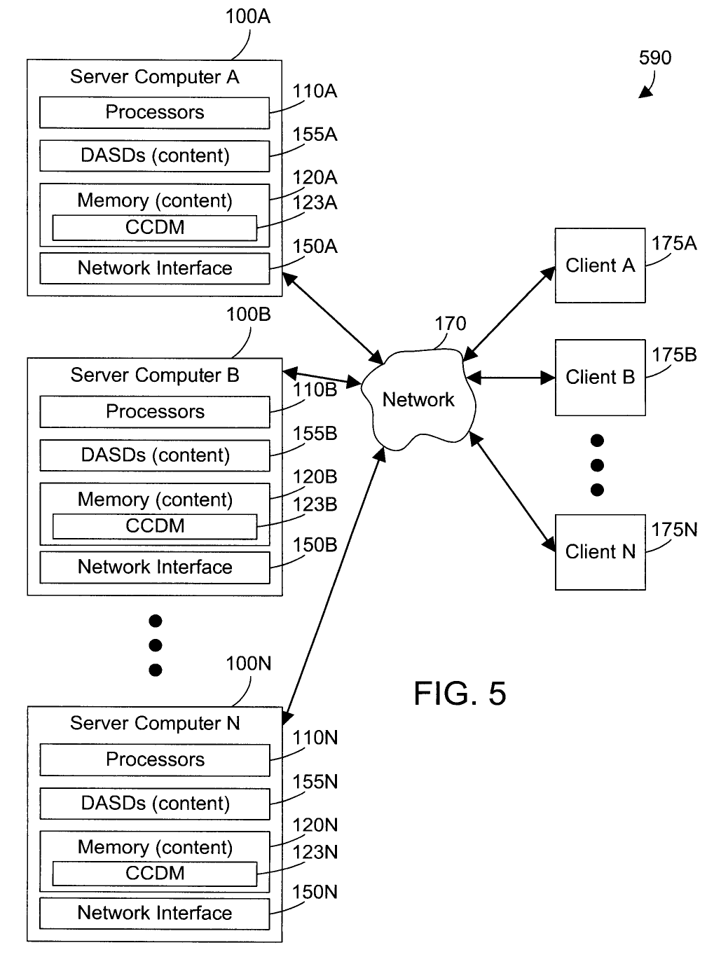

The preferred embodiments recognize that digital content may be delivered in a much more cost-effective manner using a scale out paradigm, where a large number of relatively inexpensive computer systems work together. Referring to FIG. 5, a networked computer system 590 in accordance with the preferred embodiments includes multiple server computer systems, shown in FIG. 5 as server computers 100A, 100B, . . . , 100N. An IBM Blade server is one example of a suitable server computer system. Each server includes processors, DASDs, memory, and a network interface. Thus, server computer system 100A includes processors 110A, DASDs 155A, memory 120A, and a network interface 150A; server computer system 100B includes processors 110B, DASDs 155B, memory 120B, and a network interface 150B; and likewise through server computer system 100N, which includes processors 110N, DASDs 155N, memory 120N, and a network interface 150N. Note that each server computer system includes a corresponding content controller and delivery mechanism (CCDM) 123 in its memory. Thus, server computer system 100A includes CCDM 123A; server computer system 100B includes CCDM 123B; and so forth through server computer system 100N that contains CCDM 123N. Each of the server computer systems are coupled via a network 170 to a plurality of client computer systems, shown in FIG. 5 as client 175A, client 175B, . . . , client 175N.

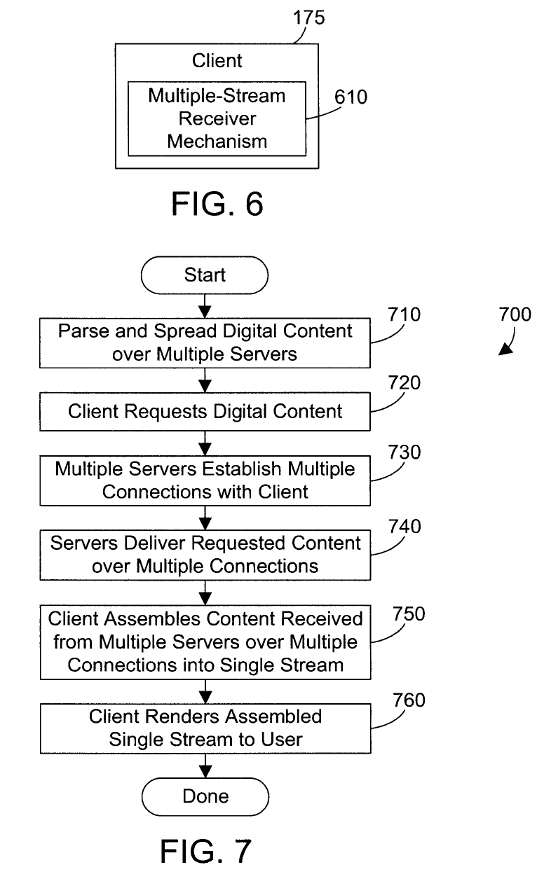

One of the keys to the “scale out” paradigm of the preferred embodiments is the ability to spread digital content across multiple server computer systems that each communicate with a client computer system on their own channel. Note that the content can be spread over multiple server computer systems using any suitable criteria or heuristic. Spreading the digital content across multiple servers that each communicate with a client on their own network channel requires the client to have the capability of assembling a data stream that comes from different servers on different channels into a single data stream that is then rendered to the user. Referring to FIG. 6, a client 175 in accordance with the preferred embodiments includes a multiple-stream receiver mechanism 610 that has the capability of aggregating multiple portions of a datastream received from multiple servers on multiple channels into a single data stream. Note that client 175 could be an enhanced set-top box, a game client (such as Playstation 2, Nintendo, etc.) or could be any other client that is capable of receiving the digital content from multiple servers. The combination of spreading the content over multiple servers that each communicate via a separate network channel with a client, and the client's ability to aggregate the digital data portions from the multiple servers into a single data stream, provides great flexibility and power for rendering on-demand digital content (such as television broadcasts) at a relatively low cost using inexpensive servers.

A method 700 in accordance with the preferred embodiments is shown in FIG. 7. First, digital content is parsed and spread across multiple servers (step 710). Next, a client requests digital content (step 720). The multiple servers over which the requested content is spread establish multiple network connections with the client (step 730). The servers then deliver the requested content over their respective connections to the client (step 740). The client then assembles the content received from the multiple servers over their respective connections into a single data stream (step 750). The client then renders the single data stream to the user (step 760).

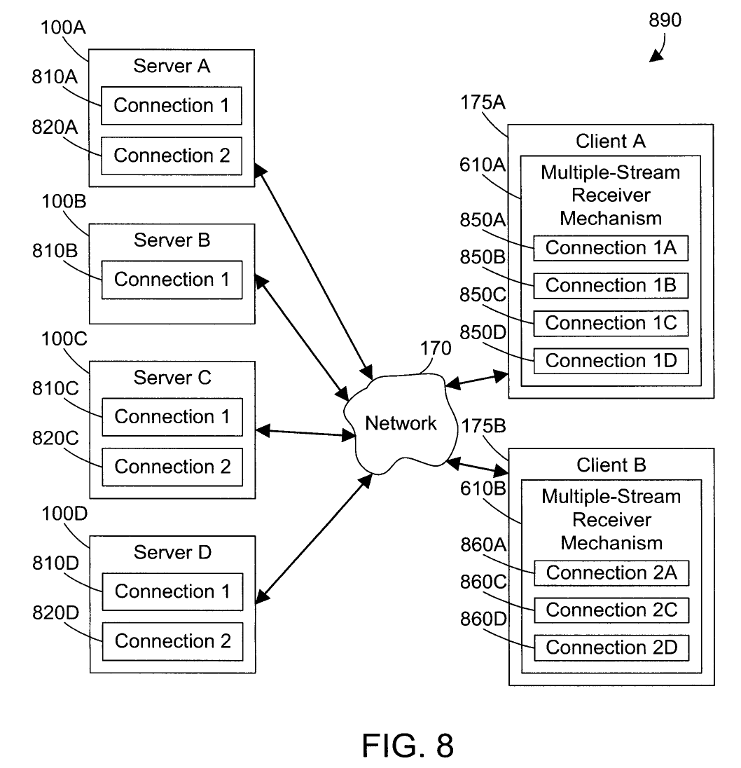

A simple example is now provided to illustrate the general concepts of the preferred embodiments. Referring to FIG. 8, we assume a networked computer system 890 includes four server computer systems 100A, 100B, 100C and 100D. Networked computer system 890 is one specific example for computer system 590 shown in FIG. 5. Each server computer system preferably includes the features shown in FIGS. 1 and 5, which are not shown in FIG. 8. We also assume two clients 175A and 175B receive digital content from the server computer systems, and that the server computer systems and client computer systems are coupled together via network 170. We assume for this simple example that digital content we'll call CONTENT A that is requested by client 175A is distributed across all four servers 100A, 100B, 100C and 100D. We further assume that digital content we'll call CONTENT B that is requested by client 175B is spread across three of the four servers, namely 100A, 100C and 100D. Note that each server includes a connection that corresponds to the content being delivered. Thus, server 100A includes a first connection 810A over which is delivered to client 175A the portions of CONTENT A residing in server 100A. Similarly, server 100A includes a second connection 820A over which is delivered to client 175B the portions of CONTENT B residing in server 100A. Server 100B contains portions of CONTENT A, but does not contain any portion of CONTENT B. As a result, only one connection 810B is needed to deliver to client 175A the portions of CONTENT A residing in server 100B.

Server 100C includes a first connection 810C over which is delivered to client 175A the portions of CONTENT A residing in server 100C. In addition, server 100C includes a second connection 820C over which is delivered to client 175B the portions of CONTENT B residing in server 100C. In like manner, server 100D includes a first connection 810D over which is delivered to client 175A the portions of CONTENT A residing in server 100D, and includes a second connection 820D over which is delivered to client 175B the portions of CONTENT B residing in server 100D.

Each client includes a multiple-stream receiver mechanism 610 that receives digital content from multiple servers over multiple connections, and aggregates the received digital content into a single data stream that is rendered to the user. For the specific example in FIG. 8, the multiple-stream receiver mechanism 610A includes four connections 850A-D that each receive data from corresponding servers 100A-D. Thus, connection 810A in server 100A sends data to connection 850A in client 175A; connection 810B in server 100B sends data to connection 850B in client 175A; connection 810C in server 100C sends data to connection 850C in client 175A; and connection 810D in server 100D sends data to connection 850D in client 175A. When the digital content is spread across the servers, the respective portions are allocated sequence numbers. The multiple-stream receiver mechanism 610A simply receives the portions of the digital content from the various servers, and assembles these portions according to their sequence numbers to generate a single data stream for CONTENT A that may then be rendered to the user.

In similar fashion, the client 175B includes a multiple-stream receiver mechanism 610B that receives digital content from multiple servers over multiple connections, and aggregates the received digital content into a single data stream that is rendered to the user. For the specific example in FIG. 8, the multiple-stream receiver mechanism 610B includes three connections 860A, 860C and 860D that each receive data from corresponding servers 100A, 100C and 100D, respectively. Thus, connection 820A in server 100A sends data to connection 860A in client 175B; connection 820C in server 100C sends data to connection 860C in client 175B; and connection 820D in server 100D sends data to connection 860D in client 175B. The multiple-stream receiver mechanism 610B simply receives the portions of the digital content from the various servers, and assembles these portions according to their sequence numbers to generate a single data stream for CONTENT B that may then be rendered to the user. Note that the connections shown in FIG. 8 could be any suitable network connection, such as sockets in a Transmission Control Protocol/Internet Protocol (TCP/IP) system.

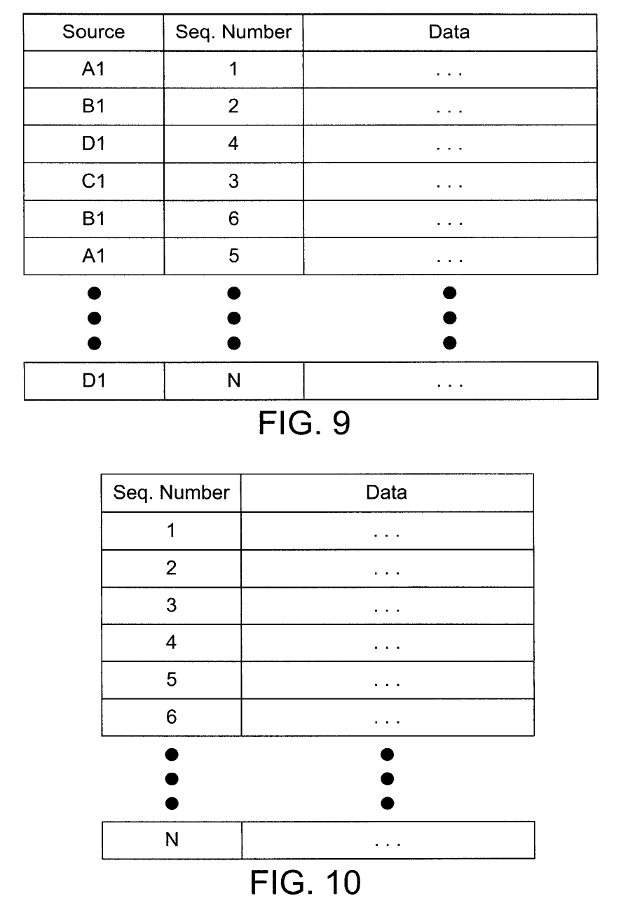

The aggregation of data received on multiple connections from multiple servers is represented by a simple example in FIGS. 9 and 10. We assume each data portion sent by a server includes a field indicating its source (i.e., which server sent the portion), a sequence number, and corresponding data. FIG. 9 represents data received from all connections in client 175A in FIG. 8 in the order they were received. We assume for this example that a source of Al means the data portion came from connection 1 (810A) in server A (100A). Similarly, all source designations denote a server, then connection number. So B1 represents server B (100B), connection 1 (810B). We see from the simple example in FIG. 9 that the first data portion was received from A1, with a sequence number of 1; the second data portion was received from B1, with a sequence number of 2; the third data portion was received from D1, with a sequence number of 4; the fourth data portion was received from C1, with a sequence number of 3; the fifth data portion was received from B1, with a sequence number of 6; the sixth data portion was received from A1, with a sequence number of 5. Note that the portions will not always be received in the correct order due to network delays and other factors. The order of receipt, however, is not critical because the data portions are assembled in sequence order, as shown in FIG. 10.

The multiple-stream receiver mechanism 610 that receives the sample data in FIG. 9 strips off the source designation, and orders the data portions according to sequence number, as shown in FIG. 10. The result is a single data stream that may then be rendered to a user. Note that the term “rendered to a user” encompasses any type of rendering of digital content to a user. Thus, a digital television broadcast is rendered to a user by playing the television program (picture and audio) for the user. A digital audio selection is rendered to the user by playing the audio file. Digital data that includes executable code is rendered to the user by executing the received executable code. The preferred embodiments expressly extend to any manner of rendering digital content to a user, whether currently known or developed in the future.

In the “scale up” paradigm shown in FIGS. 2-4, memory and network capacity become serious bottlenecks to performance. In the “scale out” paradigm of the preferred embodiments, both memory and network capacity can be easily expanded by adding more servers. As a result, the preferred embodiments provide a way to deliver on-demand digital content that has greater flexibility and lower cost. The preferred embodiments spread digital content across many relatively inexpensive servers, send the digital content over respective connections to a client, with the client aggregating the data from multiple servers sent over multiple connections into a single data stream that is rendered to the user. By spreading content across multiple servers that deliver the content over multiple connections to a client, the cost of providing on-demand digital content to a large number of users is greatly reduced.

Note that the term “single data stream” is used herein to denote that multiple data streams received over multiple connections from multiple servers are aggregated into one data stream. Some digital content may actually include multiple data streams. For example, a stereo audio program may include two data streams, one for the left channel and one for the right channel. The term “single data stream” is used herein to describe the function of aggregating multiple data streams into one data stream, and should not be construed as limiting the preferred embodiments to digital content that must be delivered in a single data stream. Thus, for the example above of a stereo audio program, each channel may be spread across multiple network elements (or servers), and the client would then aggregate the data for the left channel into a first single stream, and aggregate the data for the right channel into a second single stream. The preferred embodiments expressly extend to digital content that includes multiple streams of data. For example, a video frame could include different data streams for left channel audio, right channel audio, center channel audio, video stream, closed caption, etc. that are all rendered simultaneously and synchronously. Each of these could be a “single data stream” within the scope of the claims herein, even though multiple data streams are present. In addition, multiple data streams could be rendered to multiple locations within the scope of the preferred embodiments. Thus, a television broadcast could include multiple streams for multiple audio channels as discussed above, and a separate stream that allows a user to perform web browsing while watching television.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A networked computer system comprising:
a client computer system that requests digital content; and
a plurality of server computer systems each connected via at least one network connection to the client computer system, each of the plurality of server computer systems including a portion of the digital content, wherein each of the plurality of server computer systems delivers its respective portion of the digital content to the client computer system via a network connection that is not used by any of the other server computer systems.

2. The networked computer system of claim 1 wherein the digital content is parsed into a plurality of portions that are spread across the plurality of server computer systems.

3. The networked computer system of claim 1 wherein the client computer system comprises a multiple-stream receiver mechanism that receives the portions of the digital content from the plurality of server computer systems and assembles the portions of the digital content into a single data stream.

4. The networked computer system of claim 3 wherein the client computer system renders the single data stream to a user of the client computer system.

5. The networked computer system of claim 1 wherein each of the plurality of server computer systems comprise:
a mass storage device;
a memory; and
a content controller and delivery mechanism residing in the memory that determines which portions of the digital content to place in the memory and which portions of the digital content to place in the mass storage device.

6. A computer-implemented method for delivering digital content to a client computer system from a plurality of server computer systems, the method comprising the steps of:
(A) the client computer system requesting the digital content; and
(B) the plurality of server computer systems each delivering a portion of the digital content to the client computer system via a network connection that is not used by any of the other server computer systems.

7. The method of claim 6 further comprising the step of parsing the digital content into a plurality of portions spread across the plurality of server computer systems.

8. The method of claim 6 wherein the client computer system receives the portions of the digital content from the plurality of server computer systems and assembles the portions of the digital content into a single data stream.

9. The method of claim 8 wherein the client computer system renders the single data stream to a user of the client computer system.

10. The method of claim 6 wherein each of the plurality of server computer systems determines which portions of the digital content to place in memory and which portions of the digital content to place in mass storage.

11. A computer-readable program product comprising:
a content controller and delivery mechanism that sends a plurality of portions of digital content spread across a plurality of server computer systems from the plurality of computer systems to a client computer system via a network connection that is not used by any of the other server computer systems; and
recordable media bearing the content controller and delivery mechanism.

12. The program product of claim 11 wherein the client computer system comprises a multiple-stream receiver mechanism that receives the portions of the digital content from the plurality of server computer systems and assembles the portions of the digital content into a single data stream.

13. The program product of claim 12 wherein the client computer system renders the single data stream to a user of the client computer system.

14. The program product of claim 11 wherein the content controller and delivery mechanism determines which portions of the digital content to place in memory and which portions of the digital content to place in a mass storage device.
